(19) United States
(12) Patent Application Publication
(10) Pub. No.: US 2010/0325363 A1
(43) Pub. Date: Dec. 23, 2010

(54) HIERARCHICAL OBJECT CACHING BASED ON OBJECT VERSION

(75) Inventors: Anders Olesen, Copenhagen (DK); Mehmet K. Kiziltunc, Glostrup (DK); Thomas Hejlsberg, Horsholm (DK); Kim C. Olsen, Vordingborg (DK); Dean McCrae, Kastrup (DK)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/489,358

(22) Filed: Jun. 22, 2009

(51) Int. Cl. G06F 12/08; G06F 12/00

(52) U.S. Cl. 711/135; 711/141; 711/E12.001; 711/E12.022

(57) ABSTRACT

A method and system for hierarchical caching of objects of an ERP system is provided. A caching system comprises a server cache component that is executed by a server and a client cache component that is executed by each client of the server. The server cache component maintains a server cache at the server, and the client cache component maintains a client cache at each client. The client cache components also cache the objects in local client caches. Upon opening an object, the client cache component checks its local client cache to determine whether the object is cached. If so, then the client cache component need not retrieve the object from the server. Thus, the caching system is hierarchical in that each server and client maintains its own cache.

### BACKGROUND

Enterprise Resource Planning (“ERP”) software is a type of software used by many companies to plan and manage various business functions, such as budgeting, accounting, human resources, inventory, customer relationships, and so on. ERP software typically provides access to a database from which users and applications may retrieve information related to the various business functions. Users and application resources typically interact with the database via a plurality of database objects. For example, a table object may provide access to a data table, while a form object may provide the code necessary for displaying a form that can be used to access data within a table. As another example, a code unit may provide logic for manipulating the data and objects associated with the database. In addition to the above-mentioned objects, typical objects may also include reports, records, menu suites, data ports, pages, XML ports, and so on. These objects may be considered to be metadata because they contain information that describes the layout of forms, schema of a database table, and so on.

ERP software is typically implemented as part of an ERP system that is based on a client/server model. A server of the ERP system functions as a front end of the database holding the objects and includes server components that provide server-side business logic. The clients of the ERP system include client components that interact with the server to perform functions requested by a user. When a user requests a function to be performed, the client may send a request to the server for objects that are needed to satisfy the request. For example, the client may need a form object and a table object relating to customer information to satisfy a request to update customer information. Upon receiving the request, the server then accesses the database to retrieve the objects needed to satisfy the request. Upon receiving the objects from the database, the server sends those objects to the client to provide the function requested by the user.

After the function is performed, the user may request to perform another function. As part of the performing of the other function, the client may discard or close the objects previously used by the previous function. If, however, the user later decides to again perform the previous function, the client would again send a request to the server for the objects needed to perform that previous function. As described above, the server then retrieves the objects from the database and responds by providing the retrieved objects to the client again. Such repeated sending of requests and subsequent responses may provide an unacceptable overhead on an ERP system. The overhead may also increase dramatically as the number of clients increases. Each time a client sends a request to the server, the server retrieves the needed objects from the database and sends to the client a response that includes objects retrieved from the database. As a result, when two clients each send a request that requires a customer form object and a customer table object, the server needs to perform two retrievals from the database for each object. Although some database systems may provide caching functionality to improve performance when repeatedly accessing the same object, the server still needs to send a request to the database to retrieve the needed objects even though they may be cached by the database.

Part of the overhead of such repeated retrieving of objects from the server results from the ability to dynamically update the objects of an ERP system. For example, while one client is currently displaying a form to a user, a user at another client may be updating that same form (e.g., adding an extra field or changing the background color) and saving the update to the database. In order for the clients to have the most current object, the clients may need to close the objects that they have been provided and reopen the objects so that the most current object can be retrieved from the server. This results in additional and repeated retrieval and sending of objects.

### SUMMARY

A method and system for hierarchical caching of objects of an ERP system is provided. A caching system comprises a server cache component that is executed by a server and a client cache component that is executed by each client of the server. The server cache component maintains a server cache at the server, and the client cache component maintains a client cache at each client. The server cache caches objects retrieved from the database in response to a request from a client. The client cache components also cache the objects in local client caches. Upon opening an object, the client cache component checks its local client cache to determine whether the object is cached. If so, then the client cache component need not retrieve the object from the server. Thus, the caching system is hierarchical in that each server and client maintains its own cache. Since an ERP system may allow dynamic updating of objects, the objects stored in a cache may not be current. The client cache components and the server cache component interact to ensure that clients are notified when their local client caches are not current. Also, a client/server model may consist of multiple levels of a hierarchy in that a client of a server may function as a server for other clients.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a hierarchical organization of servers and clients in some embodiments.

FIG. 2 is a block diagram illustrating components that comprise the server cache component of the caching system in some embodiments.

FIG. 3 is a block diagram illustrating components of the client cache component of the caching system in some embodiments.

FIG. 4A is a block diagram illustrating contents of a cache in some embodiments.

FIG. 4B is a diagram illustrating request and response messages sent between a client and a server in the caching system in some embodiments.

FIG. 5 is a flow diagram that illustrates the processing of the get object component of the client cache component in some embodiments.

FIG. 6 is a flow diagram that illustrates the processing of the process updates component of the client cache component in some embodiments.

FIG. 7 is a flow diagram that illustrates the processing of the get object component of the server cache component in some embodiments.

FIG. 8 is a flow diagram that illustrates the processing of the check for updates component of the server cache component in some embodiments.

FIG. 9 is a flow diagram that illustrates the processing of the object update component of the server cache component in some embodiments.

### DETAILED DESCRIPTION

A method and system for hierarchical caching of objects of an ERP system is provided. In some embodiments, a caching system comprises a server cache component that is executed by a server and a client cache component that is executed by each client of the server. The server cache component maintains a server cache at the server, and the client cache component maintains a client cache at each client. The server cache caches objects retrieved from the database in response to a request from a client. For example, when a first client requests a customer form object, the server cache component checks its cache to determine whether the customer form object has been cached. If so, the server cache component retrieves the customer form object from the server cache and returns it to the first client. If not, the server component retrieves the customer form object from the database, stores it in the server cache, and returns it to the first client. When a second client requests the customer form object, the server cache component determines that the object is in the server cache and returns it to the second client without accessing the database. The client cache components for both the first client and the second client also cache the objects in their local client caches. Either client may subsequently close and then open a cached object. Upon opening the object, the client cache component checks its local client cache to determine whether the object is cached. If so, then the client cache component need not retrieve the object from the server. Thus, the caching system is hierarchical in that each server and client maintains its own cache. Since an ERP system may allow dynamic updating of objects, the objects stored in a cache may not be current. As described below in more detail, the client cache components and the server cache component interact to ensure that clients are notified when their local client caches are not current. Also, as described in more detail below, the client/server model may consist of multiple levels of a hierarchy in that a client of a server may function as a server for other clients. In such a case, a single computing device provides both client and server functionality.

In some embodiments, each cache component maintains a cache of objects at the server or client. A cache of objects includes the content of each object in the cache along with its identifier and version. The identifier identifies the object, and the version identifies the version of the object. For example, a customer form object may have the identifier of “cust_form” that was assigned by the creator of that object and may have a version that may be a unique timestamp of when that object was last modified and may be assigned by the database or the server. The versions may serve as unique identifiers of objects stored in the database in that no two objects are assigned the same version or timestamp. Each cache of objects has an associated cache version to indicate the currency of the cache. The cache version may be set to the version of the most recently modified object known to its server at the time the cache was last updated. Thus, if a cache has a cache version that is less than the highest version assigned to an object, then the data in the cache might not be current. For example, if the cache contains an earlier version of that most recently modified object, then the cache is not current.

In some embodiments, when an object is modified so that it has a new version, a notification of that change propagates from the database through the hierarchy of servers. For example, a server may send to child servers or a client notifications with identifiers and versions of objects have been recently modified. Upon receiving a notification, the server or client may check its cache to see if it contains an entry for a prior version of an object identified in the notification. If so, the client component may update cache to reflect the new version and may flush the cache of the content of the prior version (if that content is still stored in the cache). In such a case, the cache is considered to contain a “marker object” in that cache does not contain the content of that object, but contains its identifier and version.

In some embodiments, the notifications of changes are propagated by augmenting responses to requests to perform actions or via update requests (e.g., pings) when requests to perform actions are infrequent. As a server receives requests from clients to perform actions, it augments the responses to the requests with cache currency information. For example, a server may receive a request from a client to retrieve a certain row of an inventory table. The request identifies the cache version of the client. In response, the server retrieves the row of the inventory table from its cache. The server also determines whether the client cache of the client that sent the request is current based on the cache version included in the request. The server determines the currency of the client cache by comparing the client cache version to the server cache version. If the client cache version is earlier than the server cache version, then at least one object has been modified since the client cache was last updated. The server may receive the client cache version from the client as part of a request as described above or may provide its current cache version in its response, so that the client can determine whether its objects are current. If the client cache is not current, the server component may identify from its cache the objects that have been modified since the client cache was last updated. The server component may then augment the response to the request with the identifiers and versions of the modified objects. Upon receiving a response, the client component updates its client cache and client cache version as appropriate. In particular, the client component may replace the client cache version with the server cache version provided in response, update entries in the change list to reflect the current version of the objects, and flush the client cache of any object that is not current.

In some embodiments, when a client needs an object, the client component determines whether the object is currently cached in the client cache. If not, the client component sends a retrieve or get request to the server to retrieve the object. If, however, it is stored in the cache, the client component does not know whether the cached object is current or not. In such a case, the client component can either continue processing with the understanding that the object may not be current or in other scenarios send a get object request to the server with the identifier and version of the object. Upon receiving the get object request, the server component checks its cache to determine whether the client has the current version of the object. If so, it sends to the client a response indicating that the version of the object is current. If not, it retrieves the current version of the object from its cache or the database and sends it to the client in the get object response. In some embodiments, while waiting for a get object response, the client may start processing using the cached version of the object. If, however, it turns out that the cached version is not current, then the client may need to restart the processing when the current version of the object is received. In other embodiments, the client might not start processing until the get object response is received.

In some embodiments, the server is notified when an object has been modified. The server may receive the notification from the database or other external services, depending on whether an external service provides such update functionality or the server itself provides such update functionality. Upon receiving a notification, the server updates the server cache as appropriate to reflect the new version of the object, server cache version and flushes the earlier version of the object stored in the cache (if any), and it may cache the current version of the object if the notification included the content of the object. The flushing of a version of an object may actually remove the content of the object from the cache and leave in the cache a marker object for the object as described above.

In some embodiments, the ERP system may provide hundreds or thousands of objects, and thus the caches may cache hundreds or thousands of objects. If the objects are updated frequently, then the overhead of providing notifications of a large number of updates and subsequent processing by the clients may be high. For example, the client would need to flush the content of each identified object from its client cache. To avoid this overhead, the caching system may provide a mechanism in which a server can notify a client to flush its entire cache, rather than individually flushing objects. Such flushing of the entire cache may be more efficient than flushing a large number (or a threshold number) of objects individually. The caching system may also subdivide a large cache into logical sub-caches. Each sub-cache may have its own sub-cache version number and a list of possible changes. By using sub-caches, the server component can notify clients to flush a sub-cache when many objects within the sub-cache have been modified, rather than having to flush the entire cache. The caching system may start out with the cache not divided and over time subdivide the cache as the number of cached objects increases. The number of sub-caches and the size of each sub-cache can vary over time to adapt to the number of objects cached and the access patterns of the clients.

In some embodiments, the caching system may track dependencies between objects. For example, a customer form object may be dependent on an address form object to provide address information for the customer form. When a client is to access an object, it needs to ensure that it has the current version of both the object being accessed and its dependent objects. For example, when the client is to display a customer form, it needs to ensure that both the customer form object and the dependent address form object are current. The client may send a verification request to the server that identifies an object and its dependent objects along with their associated versions. The server can then determine which of the object and its dependent objects are not current and return current versions of those objects for which client does not have the current version. The dependency may be derived from the definition of the object or could be a list of objects that the client wants to be at the same synchronization state.

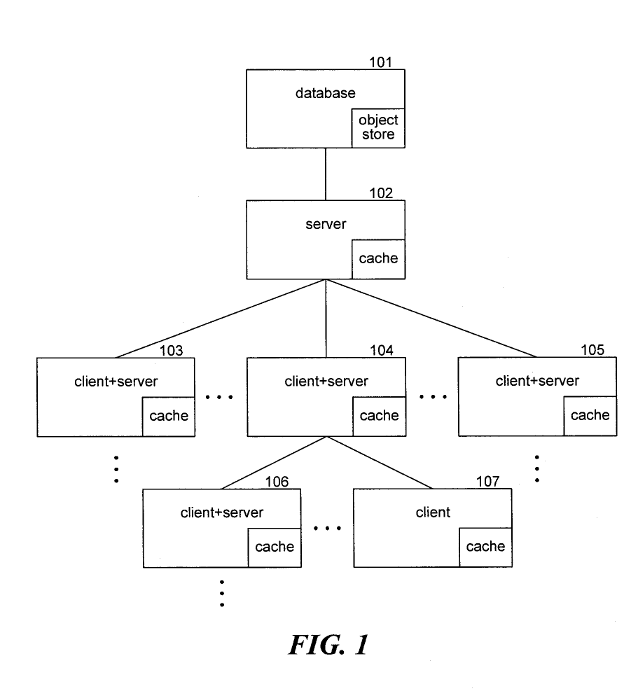

FIG. 1 is a block diagram illustrating a hierarchical organization of servers and clients in some embodiments. The database system 101 includes an object store that persistently stores the objects of the ERP system. A server 102 functions as the highest level server and a front end to the database system and maintains a local server cache. The server has connections established with various number of clients 103-105, each of which has its own local client cache. Each of the clients may also function as a server to other clients. For example, client 104 functions as a server for clients 106 and 107. Clients 106 and 107 may in turn function as servers to other clients. In this example, client 107 is a leaf client in that it does not function as a server to other clients. The hierarchical organization of servers may be of an arbitrary number of levels, with clients that do not function as servers being the lowest level of the hierarchy. When a client submits a request to retrieve an object, that request is forwarded up the hierarchy until a server is located that has a version of that object in its cache. If no server has a version of the object in its cache, the object is retrieved from the database system and then cached by the servers along the path from the database system to the requesting client. The cache components may use various algorithms for flushing cached objects from the cache in order to make room for other cached objects. For example, the cache components may use a least recently used algorithm, an algorithm based on the size of the objects, a combination of various algorithms, and so on to determine what objects to flush. As such, servers and clients in the hierarchy may have very different sets of objects currently stored in their caches and may use marker objects to identify flushed objects.

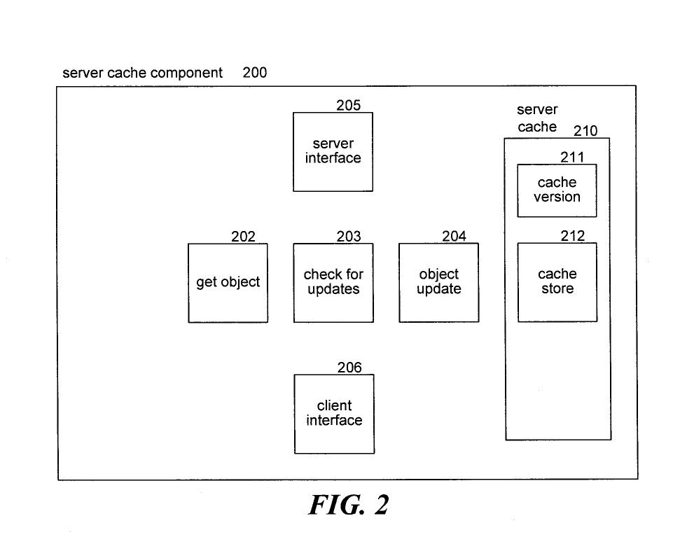

FIG. 2 is a block diagram illustrating components that comprise the server cache component of the caching system in some embodiments. The server cache component 200 may include a get object component 202, a check for updates component 203, object update component 204, a server interface component 205, and a client interface component 206. The server cache component may also include a server cache 210 that comprises a cache version 21 land a cache store 212. The get object component is invoked when a request to get an object is received from a client. The get object component may be passed a list of object identifiers to be requested along with the versions of the objects currently stored in the cache. The check for updates component is invoked to determine whether a client cache is current and to identify those objects that may not be current in the client cache. The object update component is invoked when an object has been updated. The server interface component provides an interface with the next higher level in the hierarchy, which may be another server or the database system. The client interface component provides an interface between the server and the clients of the server. The cache version identifies the version of the local server cache. The cache store contains the contents of the cached objects along with their version and identifiers. Objects cached by the server (or a client) represent those objects that are known to the server, that is, have been processed in some way by the server (or client) cache component since the server (or client) cache was last initialized (e.g., flushed and all object information cleared). In this way, the server can limit notifications of updates to only those objects that are already known to each client.

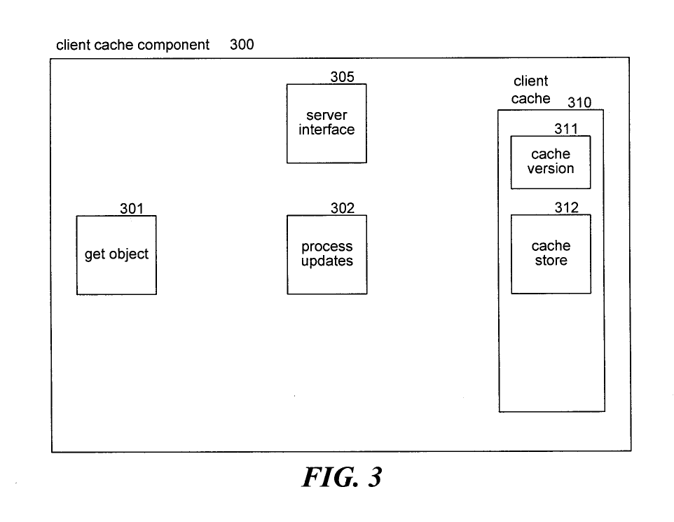

FIG. 3 is a block diagram illustrating components of the client cache component of the caching system in some embodiments. The client cache component 300 includes a get object component 301, a process updates component 302, and a server interface component 305. The client cache component also includes a client cache 310 comprising a cache version 311and a cache store 312. The get object component is invoked when a client wants to retrieve an object from the server. The process updates component is invoked when the client receives an update of object versions from the server. The server interface component provides an interface between the client and its server. The cache version identifies the cache version of the local client cache. The cache store contains the contents of the objects cached locally along with their versions and identifiers.

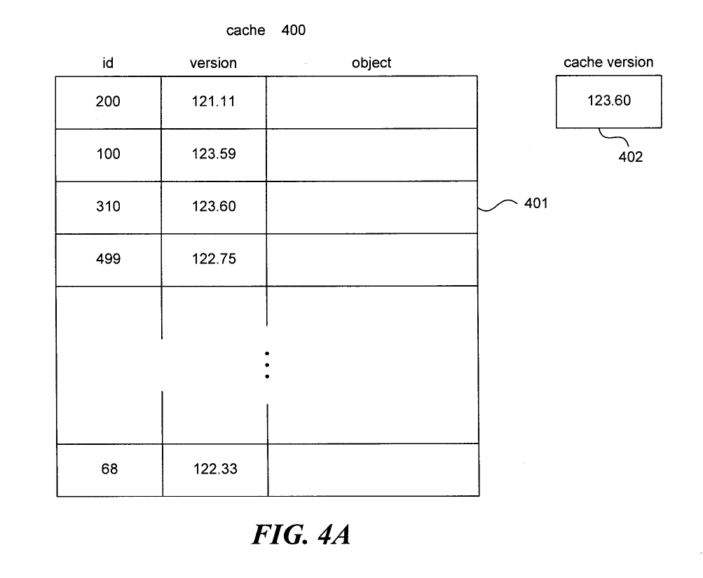

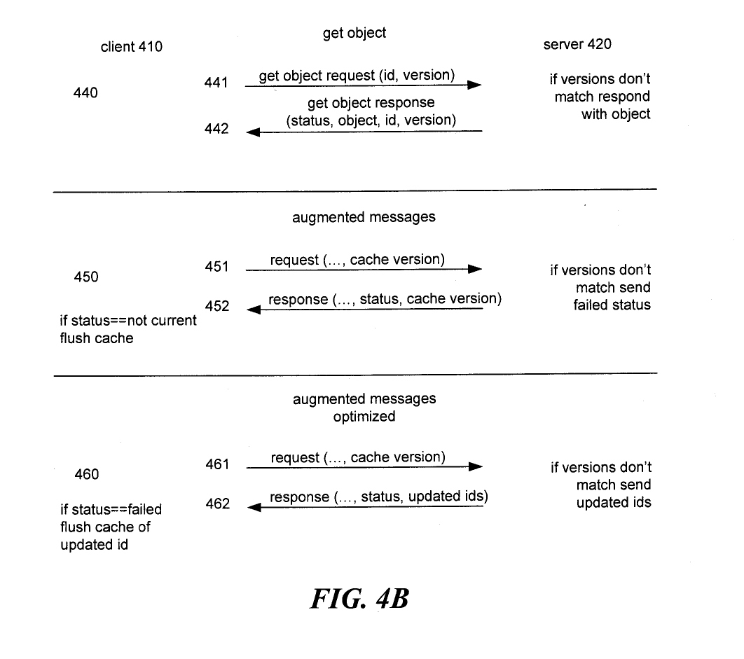

FIG. 4A is a block diagram illustrating contents of a cache in some embodiments. The cache 400 includes an entry for each object known to the client or the server. Each entry contains an identifier of an object, the version of that object known to the client or server, and the content of the object if currently cached. For example, the first entry of the cache store has an object identifier of 200 and a version of 121.11. If the object with the identifier 200 is updated, it would be assigned a new version such as 123.61. A cache version 402 contains the local cache version, which may be the highest version stored in the change list to indicate the highest version known to the client or server. Alternatively, the caching system may use a cache versioning mechanism that is independent of the version numbers assigned to the object. For example, the object versions may be a timestamp, and the cache versions may be a monotonically increasing number. Similarly, the object versions may be a monotonically increasing number that is increased whenever an object is updated.

FIG. 4B is a diagram illustrating request and response messages sent between a client and a server in the caching system in some embodiments. Messages 440 illustrate optimized communications when a client gets an object with an optional version identifier. The client initially sends to the server a get object request 441 that includes an identifier of an object and the latest version of that object known to the client. Upon receiving the request, the server determines whether the client has the current version. If so, it sends to the client a get object response 442 that indicates that the client's version is current. If the client's version is not current, then the server includes the content of the object and its current version in the get object response 442. Messages 450 illustrate the augmenting of responses to requests, which may be any arbitrary request that is unrelated to the accessing of an object, with currency information. For example, the request may be a simple periodic ping sent by the client to the server. The request, however, may include the client's cache version. The client sends to the server a request 451. Upon receiving the request, the server determines whether the client cache is current. If not, it sends a response 452 indicating that it is not current and providing the current cache version. Upon receiving the response, the client may flush its cache so that each subsequent request will result in a cache miss and a get object request sent to the server to retrieve the current version. Messages 460 illustrate an optimized augmenting of responses with object update or change information so that the entire cache need not be flushed. The client sends to the server a request 461. Upon receiving the request, the server checks to see if the client's cache version is current by comparing it to the server's cache version. If it is not current, then the server sends a response 462 augmented with the identifiers and versions of objects within the range between the client's cache version and the server's cache version. On receiving the response, the client updates its cache and cache version as appropriate. For example, the client may flush the content of any objects from its cache that are not current.

The computing device on which the caching system (server, clients, and database system) may be implemented may include a central processing unit, memory, input devices (e.g., keyboard and pointing devices), output devices (e.g., display devices), and storage devices (e.g., disk drives). The memory and storage devices are computer-readable storage media that may contain instructions that implement the caching system. In addition, the data structures and message structures may be transmitted via a data transmission medium, such as a signal on a communications link. Various communications links may be used, such as the Internet, a local area network, a wide area network, or a point-to-point dial-up connection.

The caching system may be implemented in and/or used by various operating environments. The operating environment described herein is only one example of a suitable operating environment and is not intended to suggest any limitation as to the scope of use or functionality of the caching system. Other well-known computing systems, environments, and configurations that may be suitable for use include personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The caching system may be described in the general context of computer-executable instructions, such as program modules, stored in a storage device and executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

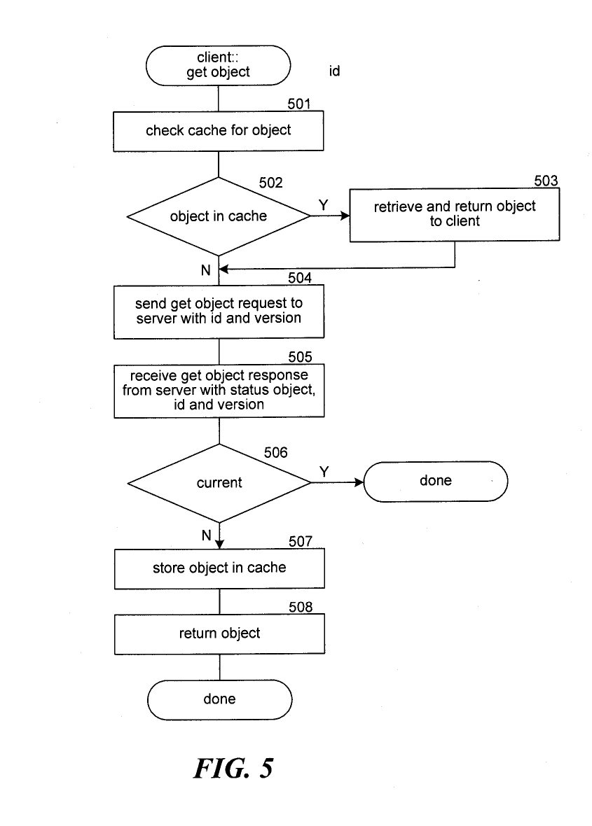

FIG. 5 is a flow diagram that illustrates the processing of the get object component of the client cache component in some embodiments. The component is invoked by the client passing the identifier of an object to be retrieved by the client. This component provides an implementation of messages 440. In block 501, the component checks the cache for the object. In decision block 502, if the object is in the cache, then the component continues at block 503, else the component continues at block 504. In block 504, the component sends a get request to the server with the identifier and version of the object. After block 504, the client can either continue execution in an asynchronous manner or wait in a synchronous manner for blocks 505-508 to complete. In block 505, the component receives from the server a get response with the content of the object (if the client's content is not current), its identifier, and its current version. In decision block 506, if the client's object is current, the component completes, else the component continues at block 507. In block 507, the component stores the object in the client cache and the client cache version as appropriate. In block 508, the component returns the object to the client and then completes.

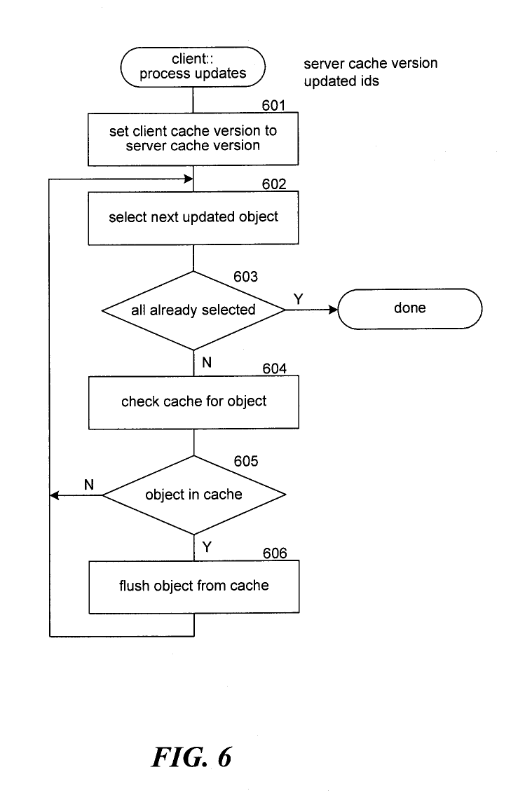

FIG. 6 is a flow diagram that illustrates the processing of the process updates component of the client cache component in some embodiments. The component is passed a server cache version and identifiers of objects and their versions that have been updated. The component is invoked when a client receives an augmented response from the server as illustrated by messages 460. In block 601, the component sets the client cache version to the server cache version. In blocks 602-606, the component loops processing the updated objects. In block 602, the component selects the next updated object. In decision block 603, if all the updated objects have already been selected, then the component completes, else the component continues at block 604. In block 604, the component checks the cache to determine whether the object is currently cached. In decision block 605, if the object is currently cached, then the component continues at block 606, else the component loops to block 602 to select the next updated object. In block 606, the component flushes the content of the object from the cache and updates the version of the object in the cache resulting in a marker object remaining in the cache.

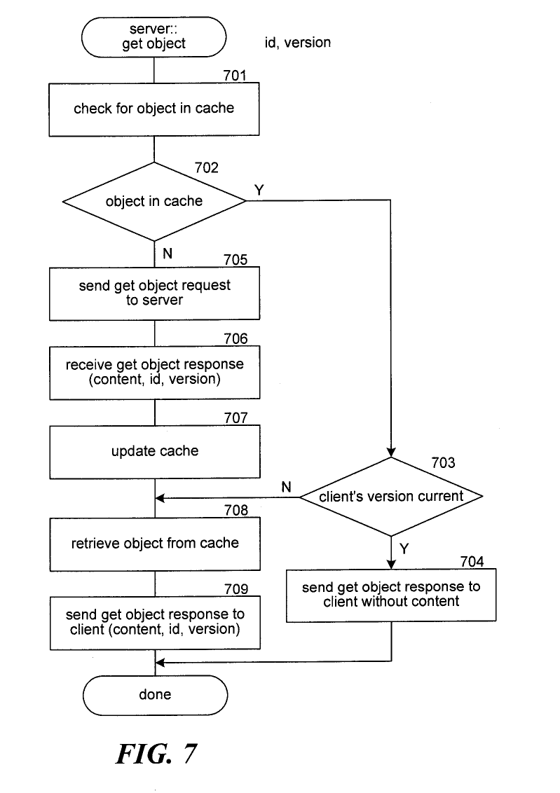

FIG. 7 is a flow diagram that illustrates the processing of the get object component of the server cache component in some embodiments. The component is invoked when a get object request is received from a client. The component is passed an identifier of an object and optionally a version. In block 701, the component checks for the object in the cache. In decision block 702, if the object is in the cache, then the component continues at block 703, else the component continues at block 705. In decision block 703, if the client's version is current, then the component continues at block 704, else the component continues at block 705. In block 704, the component sends a get object response to the client indicating that the client's version is current and without the content of the object and then completes. In block 705, the component sends to the next server a get object request. If this server is the root server in the hierarchy, the server sends the set object request to the database. In block 706, the component receives from the server a get object response that includes the content of the object and its identifier and version. In block 707, the component updates the cache version, and cache as appropriate. In block 708, the component retrieves the object from the cache. In block 709, the component sends a get object response to the client with the content of the object and its identifier and version and then completes.

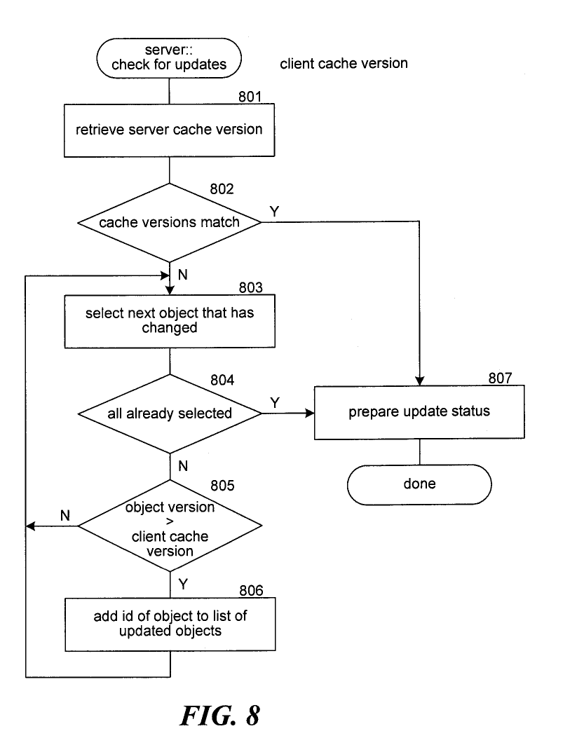

FIG. 8 is a flow diagram that illustrates the processing of the check for updates component of the server cache component in some embodiments. The component is invoked when a message from a client has been received. In block 801, the component retrieves the server cache version. In decision block 802, if the client cache version matches the server cache version, then the component continues at block 807, else the component continues at block 803. In blocks 803-806, the component loops identifying objects that have been updated since the update reflected by the client cache version. In block 803, the component selects the next object in the server cache. In decision block 804, if all the objects in the server cache have already been selected, then the component continues at block 807, else the component continues at block 805. In decision block 805, if the version of the selected object is greater than the client cache version, then the component continues at block 806, else the component loops to block 803 to select the next object in the server cache. In block 806, the component adds an identifier of the object and its version as an updated object. The component then loops to block 803 to select the next object in the server cache. In block 807, the component prepares the updated information for augmentation to the response.

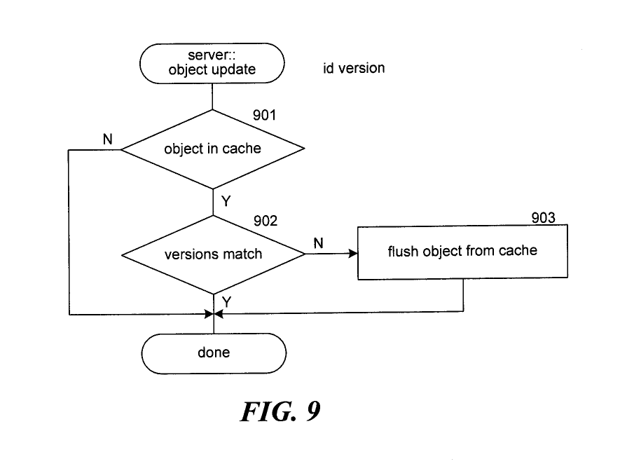

FIG. 9 is a flow diagram that illustrates the processing of the object update component of the server cache component in some embodiments. The component is invoked when an object has been updated and is passed an identifier and a version of an object. In decision block 901, if the object is in the cache, then the component continues at block 902, else the component completes. In decision block 902, if the versions of the object match, then the component completes, else the component continues at block 903. In block 903, the component flushes the current object from the cache and leaves a marker object with the new version in the cache and then completes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the caching system has been described in context of caching forms and other types of objects that may be considered to be metadata. A customer form may be considered to be metadata describing a form for display underlying customer data stored in a database. The caching system may be used to cache objects that represent metadata and objects that represent the underlying data. In some embodiments, each server may cache all objects provided to its clients. If, however, a server flushes objects from its cache, it may need to track the objects it has flushed. To track such flushed objects, it may replace each flushed object with a marker object or may maintain a separate list identifying such flushed objects. Accordingly, the invention is not limited except as by the appended claims.

I/We claim:

1. A method in a computing device of a server for maintaining coherency of a cache storing objects, the method comprising:
providing a cache of objects, each object having content, an identifier, and a version, the cache containing the content, identifier, and version of objects, the cache having a server cache version indicating a most current version of an object known to the server;
upon receiving a notification that an object has been updated, the notification including the identifier of the object and a new version of the object,
updating the server cache version to indicate the most current version of the object known to the server; and
when a prior version of the updated object is in the cache, flushing the cache of that prior version of the updated object,
receiving from a client a request to perform an action;
identifying a client cache version of the cache of the client;
when the identified client cache version does not match the server cache version,
identifying objects that have been updated since the identified client cache version; and
sending a response to the client, the response being augmented with the identifiers and versions of the identified objects, so that the client upon receiving the augmented response can identify the objects that have been updated; and
when the identified client cache version matches the server cache version, sending the response to the client without augmenting the response.

2. The method of claim 1 wherein the request includes a client cache version and the identifying identifies the client cache version from the received request.

3. The method of claim 1 wherein the versions of the objects are unique timestamps indicating when an object was last updated.

4. The method of claim 1 wherein the request is a request to get an object and when the object is not in the cache, retrieving the object from a database, storing the object in the cache, updating the server cache version when the version of the retrieved object is greater than the server cache version, and including the retrieved object and its identifier and version in the response.

5. The method of claim 1 including when the number of identified objects that have been updated since the identified client cache version is greater than a threshold, including in the response an indication for the client to flush its cache.

6. The method of claim 1 including dividing the server cache into sub-caches, maintaining a server sub-cache version, and assigning a sub-cache to each object so that when an object changes the sub-cache version of the sub-cache to which the object is assigned is changed.

7. The method of claim 6 including notifying a client of changes to objects on a sub-cache basis based on the client having a sub-cache version that is different from the sub-cache version of the server.

8. The method of claim 1 wherein objects have dependencies where when one object is accessed a dependent object is also accessed and including when the request is a request to access an object with a dependent object, determining whether the client has the current versions of the object and the current version of its dependent object.

9. The method of claim 1 wherein the identifying of the client cache version includes maintaining at the sever a client cache version for each client.

10. A computer-readable storage medium containing computer-executable instructions for controlling a client to maintain a cache of objects provided by a server, the client and the server being computing devices, by a method comprising:
providing a cache of objects, each object having content, an identifier, and a version, the cache containing the content, identifier, and version of objects, the cache having a client cache version provided by the server;
receiving from a user a request to perform an action on an object; and
upon receiving the request to perform an action on the object,
determining whether the object is in the cache;
when it is determined that the object is in the cache,
sending a request to the server to determine whether the object in the cache is current, the request including an identifier of the object and an indication of its version;
receiving from the server a response to the sent request indicating whether the object in the cache is current;
when the received response indicates that the object in the cache is not current, updating the cache and client cache version based on the received response, and using the object from the received response when performing the requested action;
when the received response indicates that the object in the cache is current, using the object from the cache when performing the requested action.

11. The computer-readable storage medium of claim 10 including:
when it is determined that the object is not in the cache,
sending a request to the server to retrieve the object;
receiving from the server a response to the sent request, the response including the object and its version; and
after receiving the response, updating the cache and client cache version as appropriate based on the received response, and using the object from the received response when performing the requested action.

12. The computer-readable storage medium of claim 10 including:
sending to the server a request to perform an action;
receiving from the server a response to the request, the response identifying a server cache version and identifiers and versions of objects that have been updated; and
updating the cache and client cache version as appropriate based on the received response.

13. The computer-readable storage medium of claim 10 wherein the cache is divided into sub-caches and a client sub-cache version is maintained for each sub-cache, and a sub-cache is assigned to each object so that when a response is received from the server, the response can identify objects that have changed for sub-caches whose client sub-cache version does not match a server sub-cache version.

14. The computer-readable storage medium of claim 10 wherein the versions of the objects are unique timestamps indicating when an object was last updated.

15. The computer-readable storage medium of claim 10 wherein the received response includes the server cache version and updating of the client cache version includes setting the client cache version to the server cache version.

16. The computer-readable storage medium of claim 10 wherein the client functions as a server of objects to other clients.

17. A server for maintaining coherency of a server cache and client caches of clients, the caches for storing objects, the server and client being computing devices, comprising:
a memory encoded with computer-executable instructions that provide:
a cache of objects, each object having content, an identifier, and a version, the cache containing the content, identifier, and version of objects, the cache having a server cache version;
a component that, when an object has been updated, updates the cache and the server cache version as appropriate;
a component that receives from a client a request to verify that the client has a current version of an object, the request including the identifier of the object and an indication of the version of the object known to the client;
a component that, when the indicated version of the object identified in the request matches a version of the identified object in the cache, sends a response to the client indicating that the client has the current version of the object; and
a component that, when the indicated version of the object identified in the request does not match the version of the identified object in the cache, sends a response to the client indicating that the client does not have the current version, the response including the current version of the object; and
a processor for executing the computer-executable instructions stored in memory.

18. The server of claim 17 wherein the component that updates the cache, the change list, and the server cache version as appropriate includes:
a component that updates the cache by flushing the object from the cache when the cache contains the object; and
a component that updates the server cache version to indicate a new version of the cache.

19. The server of claim 17 wherein a response to the request to verify includes the identifier of objects that have been updated based on updates indicated by the client cache version.

20. The server of claim 17 including a component that
receives from the client a request to get an object; and
after receiving the request,
when the object is in the cache, sends to the client a response that includes the object; and
when the object is not in the cache, retrieves the object from a database, stores the object in the cache, and sends to the client a response that includes the object.
